(19) United States
(12) Patent Application Publication
(10) Pub. No.: US 2021/0197335 A1
(43) Pub. Date: Jul. 1, 2021

(54) Data Augmentation Method Based On Generative Adversarial Networks In Tool Condition Monitoring

(71) Applicant: DALIAN UNIVERSITY OF TECHNOLOGY

(72) Inventors: Yongqing WANG, Dalian, Liaoning (CN); Mengmeng NIU, Dalian, Liaoning (CN); Kuo LIU, Dalian, Liaoning (CN); Bo QIN, Dalian, Liaoning (CN); Mingrui SHEN, Dalian, Liaoning (CN); Dawei LI, Dalian, Liaoning (CN)

(21) Appl. No.: 16/970,301

(22) PCT Filed: Feb. 28, 2020
(86) PCT No.: PCT/CN2020/077095

§ 371 Date: Aug. 14, 2020

(30) Foreign Application Priority Data
Dec. 26, 2019 (CN) 201911361333.6

(51) Int. Cl. B23Q 17/09; G06N 3/04; G06N 3/08

(52) U.S. Cl. CPC B23Q 17/0976; B23Q 17/0957; B23Q 2717/00; G06N 3/088; G06N 3/0481; G06N 3/0454

(57) ABSTRACT

The invention provides a data augmentation method based on generative adversarial networks in tool condition monitoring. Firstly, the sensor acquisition system is used to obtain the vibration signal and noise signal during the cutting process of the tool; second, the noise data subject to the prior distribution is input to the generator to generate data, and the generated data and the collected real sample data are input to the discriminator for identification, the confrontation training between the generator and the discriminator until the training is completed; then, use the trained generator to generate sample data, and determine whether the generated sample data and the actual tool state sample data are similar in distribution; finally, combined with the accuracy of the deep learning network model to predict the state of the tool to verify the availability of the generated data.

### TECHNICAL FIELD

The invention belongs to the field of mechanical processing state monitoring and specifically relates to a data augmentation method based on generative adversarial networks in tool condition monitoring.

### BACKGROUND

Tool wear is a common problem in metal cutting. The cutting edge of the tool is passivated by the machining of the material, which increases the friction between the tool and the workpiece, and also increases the power consumption. If the tool wear state cannot be judged in time, the machining quality and efficiency will be affected.

Thanks to the development of deep learning technology, it has become a very effective method to indirectly monitor tool condition by using deep learning network. However, these methods are all based on big data of processing process. In most machining processes, the tool usually works in normal state, and the data under abnormal state can be collected very small, which is prone to the problem of unbalanced data set. The lack of abnormal state sample data and the problem of data imbalance seriously affect the prediction accuracy of deep learning networks. The traditional way to expand sample data set is oversampling, but oversampling only reuses a small amount of sample information, and cannot automatically learn the data distribution characteristics of samples. Therefore, how to obtain the sample data of abnormal state has become an urgent problem to be solved.

Generative Adversarial Networks (GANs), as unsupervised learning models proposed in 2014, have broad application prospects in the field of data enhancement and processing condition monitoring. It can generate a large number of sample data by learning the distribution of a small number of samples. This feature is very suitable for solving the problem of lack of balanced sample data sets in processing condition monitoring.

### SUMMARY OF THE INVENTION

The invention provides a data augmentation method based on generative adversarial networks in tool condition monitoring, aiming at the problem that the prediction accuracy of deep learning network is difficult to improve due to the imbalance of tool condition monitoring data set. The generator and discriminator in the generative adversarial network are both multi-layer perceptron structures. Adversarial training is used between the two to complete the process of establishing the generative adversarial network model. Use the trained generator to generate sample data, and combine the deep learning network prediction model to verify the availability of the generated sample data.

The technical solution of the invention: a data augmentation method based on generative adversarial networks in tool condition monitoring. Firstly, the sensor acquisition system is used to obtain the vibration signal and noise signal during the cutting process of the tool; second, the noise data subject to the prior distribution is input to the generator to generate data, and the generated data and the collected real sample data are input to the discriminator for identification, the confrontation training between the generator and the discriminator until the training is completed; then, use the trained generator to generate sample data, and determine whether the generated sample data and the actual tool state sample data are similar in distribution; finally, combined with the accuracy of the deep learning network model to predict the state of the tool to verify the availability of the generated data; the specific steps are as follows:

First step, collect vibration and sound signals during tool cutting

Two acceleration sensors are installed on the nose of the spindle and the front bearing of the spindle respectively to collect the vibration signals during the machining process, and the acoustic sensor was installed on the worktable to collect the cutting noise signals during the machining process;

Second step, build a generative adversarial network model and conduct adversarial training

The generative adversarial network framework adopted by this method is composed of a generator and a discriminator; both the generator and the discriminator are multi-layer perceptron structures, where the generator is responsible for generating pseudo data with the same dimensions as the real data, and the discriminator is responsible for distinguishing the real data from the generated data; during the adversarial training process, the generator attempts to use the generated pseudo data to fool the discriminator to make it discriminate true, and the discriminator distinguishes the generated data and the real data by improving its discriminating ability, and the two play the game, and eventually reach Nash equilibrium, that is, the sample data generated by the generator is no different from the real sample data, and the discriminator cannot distinguish the generated sample data from the real sample data;

The number of tool state samples collected by this method is 1, and the dimension of the vibration signal is 6000, which is set to {v⁽ⁱ⁾}ᵢ₌₁^{l}, where v⁽ⁱ⁾∈ [symbol] ^{(m)}, m=6000, the dimension of the noise data set is 1000, which is set to {n⁽ⁱ⁾}ᵢ₌₁^{l}, where n⁽ⁱ⁾∈ [symbol] ^{(k)}, k=1000, the tool state data set {tool⁽ⁱ⁾}ᵢ₌ₗ^{l}={v⁽ⁱ⁾, N⁽ⁱ⁾}ᵢ₌ₗ^{l}, where tool⁽ⁱ⁾∈ [symbol] ^{(u)}, u=7000; the tool state data set of the input discriminator is normalized by the maximum-minimum method, so that the input data is converted into a number between [0,1], and after the sample data is generated, the inverse normalization processing is carried out, the form of normalization function is shown in formula (1), and the form of inverse normalization function is shown in formula (2):

$$\begin{matrix}{tool}^{( i ) ′} = \frac{{tool}^{( i )} - {tool}_{min}^{( i )}}{{tool}_{max}^{( i )} - {tool}_{min}^{( i )}} & ( 1 ) \\ {tool}^{( i )} = ( {tool}_{max}^{( i )} - {tool}_{min}^{( i )} ) * {tool}^{( i ) ′} + {tool}_{min}^{( i )} & ( 2 )\end{matrix}$$

Where, tool⁽ⁱ⁾ is the original data of the tool state, tool⁽ⁱ⁾′ is the normalized data, toolₘᵢₙ⁽ⁱ⁾ is the minimum number in the data sequence, toolₘₐₓ⁽ⁱ⁾ is the maximum number in the sequence;

Both the generator and the discriminator use a three-layer fully connected neural network. The input data set is the normalized data set. The mapping formula from the input layer to the hidden layer and the hidden layer to the output layer is shown in equation (3):

hⁱƒ_{θ}(w*tool⁽ⁱ⁾′+b) (3)

Where, ƒ is the activation function and θ={w, b} is the parameter matrix of the network, where w is the connection weight between neurons in the input layer, hidden layer, and output layer, and b is the threshold of neurons in the hidden layer and output layer;

The activation function of the hidden layer uses the ReLU function, and the function form is as shown in formula (4):

$$ReLU ( x ) = \{ \begin{matrix}x & if x < 0 \\ 0 & if x \geq 0\end{matrix} \qquad ( 4 )$$

The activation function of the output layer uses the Sigmoid function, and the function form is as shown in formula (5):

$$f ( x ) = \frac{1}{1 + {e}^{- x}} \qquad ( 5 )$$

The output of the discriminator is a binary classification, the last layer uses the Sigmoid function, and the output probability value is shown in equation (6):

$$p ( y = 1 \vert x ) = \frac{1}{1 + {e}^{- {θ}^{{T}_{x}}}} \\ p ( y = 0 \vert x ) = 1 - p ( y = 1 \vert x ) = \frac{{e}^{- {θ}^{{T}_{x}}}}{1 + {e}^{- {θ}^{{T}_{x}}}} \qquad ( 6 )$$

The objective function set by this method is shown in equation (7):

$${min}_{G} {max}_{D} V ( D , G ) = {E}_{x ∼ {P}_{data} ( x )} [ log D ( x ) ] + {E}_{z ∼ {P}_{z} ( z )} [ log ( 1 - D ( G ( z ) ) ) ] \qquad ( 7 )$$

The objective function and optimal solution of the discriminator are shown in equations (8) and (9):

$$\begin{matrix}{max}_{D} V ( D , G ) = {E}_{x ∼ {P}_{data} ( x )} [ log D ( x ) ] + {E}_{z ∼ {P}_{z} ( z )} [ log ( 1 - D ( G ( z ) ) ) ] & ( 8 ) \\ {D}_{G}^{*} ( x ) = \frac{{p}_{data} ( x )}{{p}_{data} ( x ) + {p}_{z} ( x )} & ( 9 )\end{matrix}$$

The objective function of the generator is shown in equation (10):

$${min}_{G} V ( D , G ) = {E}_{z ∼ {P}_{z} ( z )} [ log ( 1 - D ( G ( z ) ) ) ] \qquad ( 10 )$$

Where, P_{data}(x) is the data distribution of the tool state data set {tool⁽ⁱ⁾′}ᵢ₌₁^{l}, and P_{z}(z) is a prior noise distribution; D(x) represents the probability that x comes from {tool⁾ⁱ⁾′}ᵢ₌₁^{l}; D(G(z)) represents the probability that G(z) comes from generated data, where G(z) is the sample data generated by the generator from the noise data that obey the prior distribution; E_{x˜P}_{_{data}}_{(z)} represents the expectation of x from the data distribution of {tool⁽ⁱ⁾′}ᵢ₌₁^{l}, E_{z˜P}_{_{z}}_{(z)} represents the expectation of z from the noise distribution; the goal of the discriminator is to maximize the error function to distinguish between real data and generated data, and the generator is to minimize the error function and generate data samples that are closer to the real sample data distribution;

Based on the objective function, the Adam optimization algorithm is used to update the parameters;

The training steps of the generative adversarial network are as follows:
(1) The generator generates p false tool state data samples {toolF⁽ⁱ⁾′}ᵢ₌₁^{p} from random noise;
(2) The generated sample data {toolF⁽ⁱ⁾′}ᵢ₌₁^{p} with label 0 and original sample data {tool⁽ⁱ⁾′}ᵢ₌₁^{l} with label 1 are mixed and input into the discriminator; based on the loss function, the parameters of the generator are fixed, only the parameters of the discriminator are updated, and the discriminator is trained to improve the discriminator's ability to distinguish true and false samples;
(3) After the discriminator is trained, the label of the generated sample {toolF⁽ⁱ⁾′}ᵢ₌₁^{p} is set to 1; based on the loss function, the error is back-propagation. In this stage, the parameters of the discriminator are frozen and cannot be updated, only the parameters in the generator can be updated, and the generator is trained to produce more real data samples;
(4) Steps (1) to (3) are a training period. After completing a period, the training process starts again from (1); after repeating multiple cycles of training the discriminator and generator, the generator's network parameters are saved;

Third step, compare the similarity between the generated data and the real data

Use the trained generator to generate sample data, compare and analyze the time-frequency graph of the generated tool state sample data {toolF⁽ⁱ⁾′}ᵢ₌₁^{p} and the real tool state sample data {toolF⁽ⁱ⁾′}ᵢ₌₁^{p}, and determine whether the distribution of the generated sample data and the real sample data is the same; if they are the same, the generated sample data is denormalized, {toolF⁽ⁱ⁾′}ᵢ₌₁^{p} is the generated tool state sample data after denormalization, and {toolF⁽ⁱ⁾′}ᵢ₌₁^{p} will be added to the original unbalanced data set {toolF⁽ⁱ⁾′}ᵢ₌₁^{p}, the enhanced data set is {toolmix⁽ⁱ⁾}ᵢ₌₁^{l+p}{{toolF⁽ⁱ⁾}ᵢ₌₁^{p}; {tool⁽ⁱ⁾}ᵢ₌₁^{l}}; if they are not the same, return to the generative adversarial network to continue adversarial training, until the distribution of the generated sample data and the real sample data is the same;

Fourth step, verify the availability of the generated sample data

The original unbalanced data set and the enhanced data set are used to train the deep learning network model to test the prediction accuracy of the two and verify the availability of the generated data; the training set and the test set do not have any intersection, and the test set is composed of real data.

Compared with the prior art, the beneficial effects of the present invention are:
1. The generative adversarial network model adopted in the invention can learn the distribution of data, generate sample data with the same distribution as the original data, and effectively enhance the training data set.
2. The present invention utilizes the enhanced data set to train the deep network model, which can effectively improve the accuracy of tool condition monitoring.

### DRAWINGS

FIG. 1 is a flow chart for a data augmentation method based on generative adversarial networks in tool condition monitoring.

FIG. 2 is a schematic diagram of the sensor installation location.

FIG. 3 is a structural diagram of generative adversarial networks adopted by the present invention.

FIG. 4(a) is the time domain diagram, 4(b) is the spectrum diagram.

FIG. 5(a) is the training process of the deep learning network, and 5(b) is the prediction result of the deep learning network.

In the picture: 1 workpiece holder; 2 workpiece; 3 machine tool gear box; 4 microphone; 5 bed; 6 1# three-way acceleration sensor; 7 cutter bar; 8 2# three-way acceleration sensor; 9 cutter bar holder.

### DETAILED DESCRIPTION

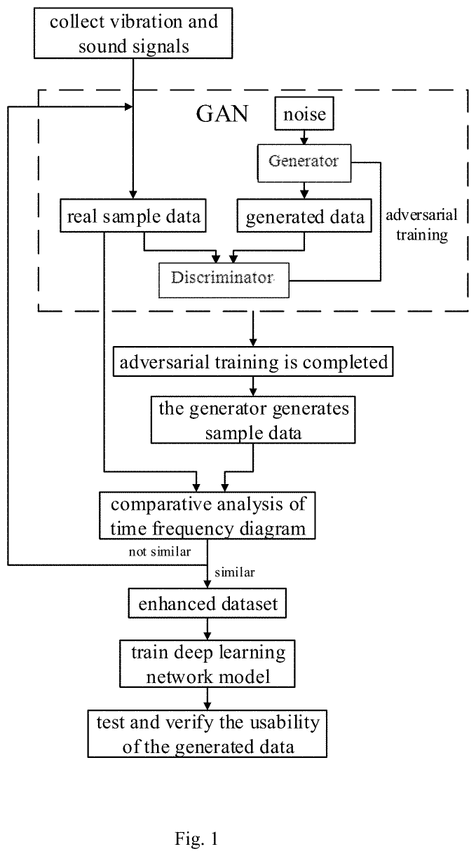

In order to make the objects, technical solutions, and advantages of the present invention more clear, an embodiment of the present invention will be described in detail with reference to FIG. 1 by taking a boring process of a domestic-made deep hole boring machine as an example.

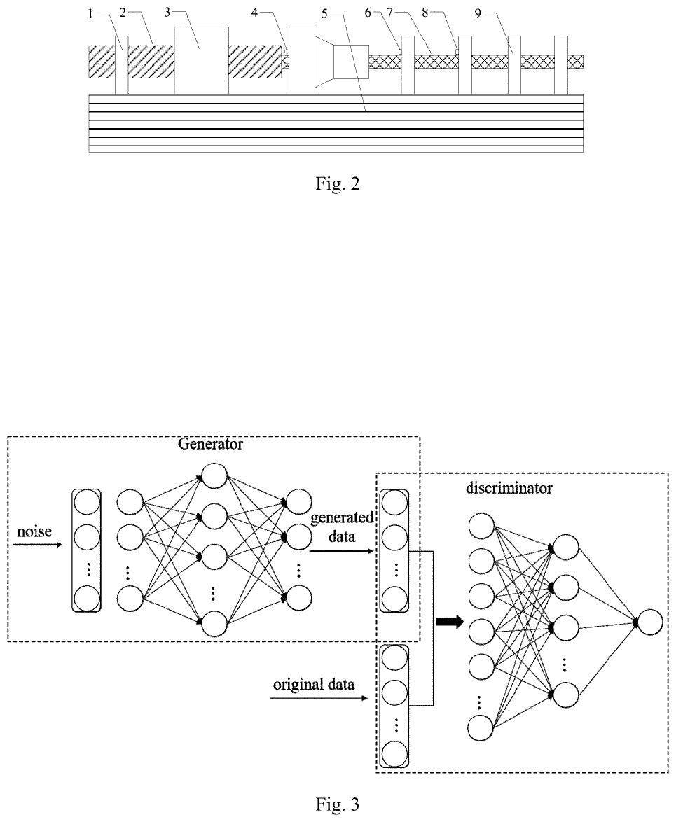

The two three-way acceleration sensors are adsorbed and pasted on the two cage bearings of the deep hole boring bar through the magnetic base, and the sound sensor is placed at one end of the inner hole of the workpiece to collect the cutter bar vibration and cutting noise in the process of machining. The installation position of the sensor is shown in FIG. 2. The three types of sample data collected are shown in Table 1. Each sample contains 7000 data points (6000 for vibration signals and 1000 for noise signals):

TABLE 1
Sample size

| tool state | normal | broken | Blunt |
|---|---|---|---|
| number of | 1360 | 87 | 22 |
| samples | | | |

The sample data of the blunt state in Table 1 is obviously less than the sample data of the normal state and the broken state, so we generate the sample data of the blunt state.

In the generative adversarial network model adopted by the invention, the generator and the discriminator both adopt a three-layer fully connected neural network model, in which the number of neurons in the hidden layer of the generator and discriminator is set to 125, and the number of neurons in the input layer of the generator is 100. The network structure is shown in FIG. 3. The learning rate is set to 0.001, the batch size is 12, the number of iterations is set to 100, and the input noise distribution obeys the uniform distribution of interval [−1, 1]. The ratio of real sample data to generated sample data in the blunt state is 1:3.

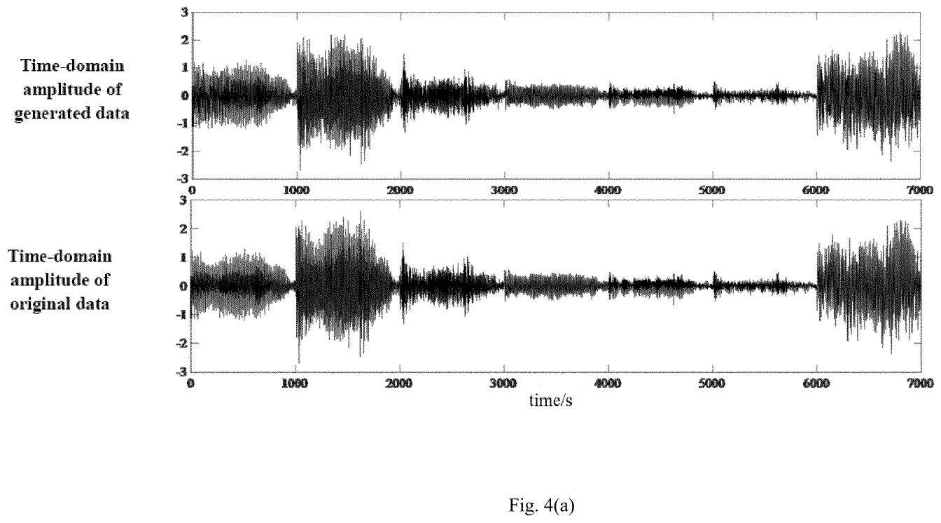

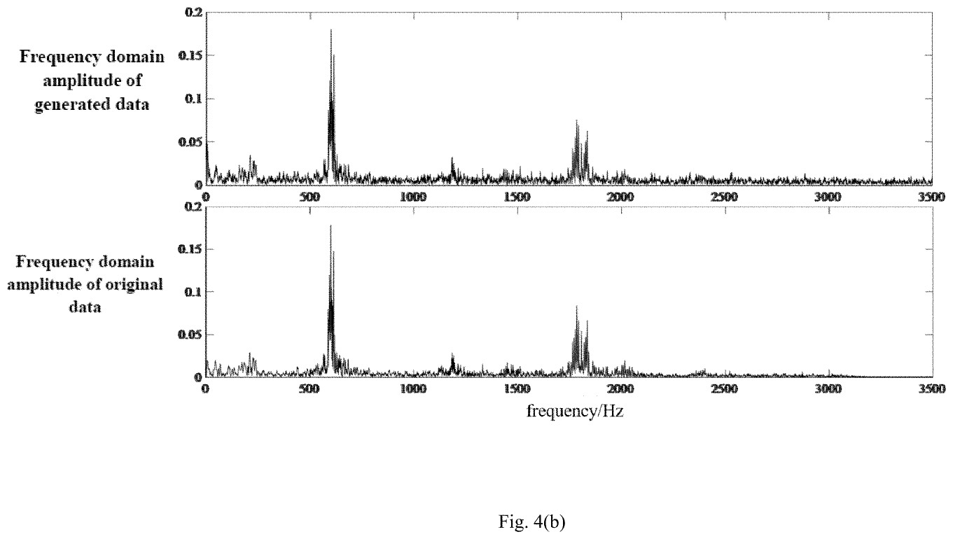

The trained generator is used to generate sample data, and MATLAB is used to make the time-frequency diagram of the real sample data and the generated sample data, as shown in FIGS. 4(a) and 4(b). It can be seen from the time domain diagram and spectrum diagram that the distribution similarity between the real sample data and the generated sample data is high.

The deep learning network adopts the deep belief networks model, and the parameter settings are as follows: the learning rate is 0.001; the number of iterations of the unsupervised training process is 100, and the number of iterations of the fine-tuning process is 200. The hidden layer has three layers, and the number of neurons in each layer is 100, 60, and 30, respectively. Since the momentum gradient descent method is superior to the gradient descent method, we use the momentum gradient descent method to optimize the parameters, and the momentum term is 0.9. The sample data is shown in Table 2. The original unbalanced data set and enhanced data set are divided into training set and test set according to the ratio of 4:1, respectively. The network is trained by training set and tested on the test set.

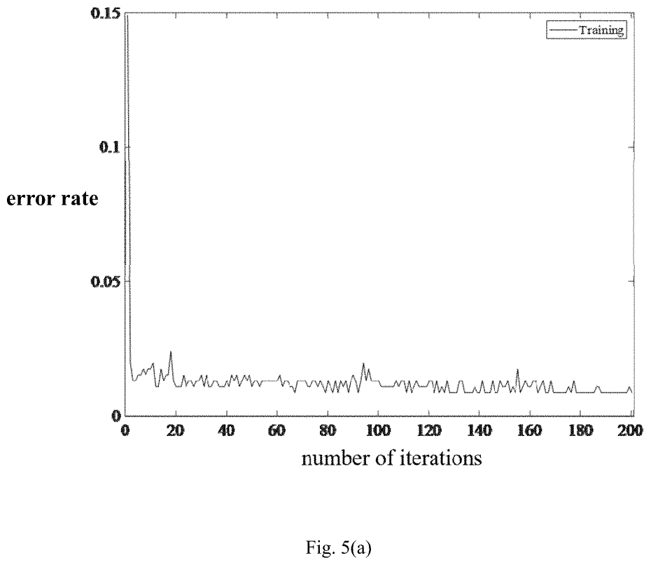

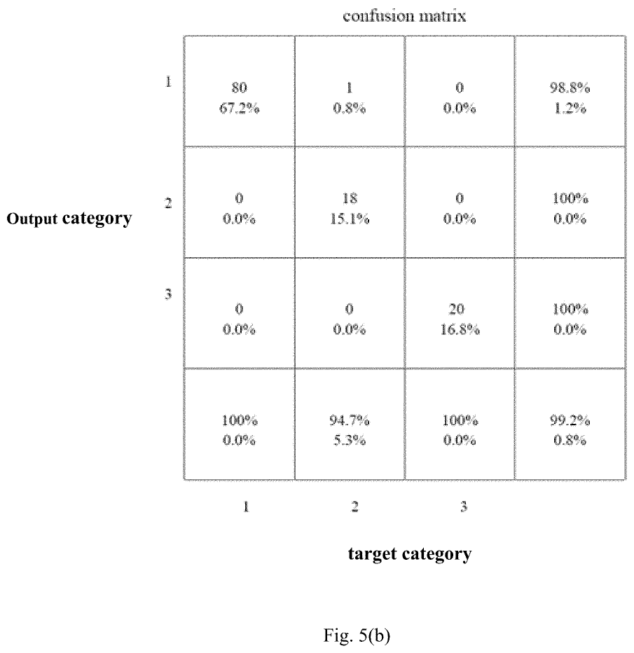

From the results, the test accuracy of the unbalanced data set is 97.1%, and the error rate is 2.9%; the test accuracy of the enhanced data set is 99.2%, and the error rate is 0.8%. The comparison between the two shows that the prediction accuracy of the deep learning network model has increased by 2.9%, while the error rate has dropped by more than three times. This verifies the availability of the generated sample data. The training process and training results of the enhanced data set on the deep learning network are shown in FIGS. 5(a) and 5(b).

TABLE 2
Sample size

| tool state | normal | broken | Blunt |
|---|---|---|---|
| number of | 1360 | 87 | 88 |
| samples | | | |

1. A data augmentation method based on generative adversarial networks in tool condition monitoring, firstly, sensor acquisition system is used to obtain vibration signal and noise signal during cutting process of the tool; second, noise data subject to prior distribution is input to generator to generate data, and the generated data and collected real sample data are input to discriminator for identification, confrontation training between the generator and the discriminator until training is completed; then, use the trained generator to generate sample data, and determine whether the generated sample data and actual tool state sample data are similar in distribution; finally, combined with accuracy of deep learning network model to predict state of the tool to verify availability of the generated data; wherein the steps are as follows:
first step, collect vibration and sound signals during tool cutting
two acceleration sensors are installed on nose of spindle and front bearing of the spindle respectively to collect the vibration signals during machining process, and acoustic sensor is installed on worktable to collect cutting noise signals during the machining process;
second step, build a generative adversarial network model and conduct adversarial training
the generative adversarial network framework adopted by the method is composed of a generator and a discriminator; both the generator and the discriminator are multi-layer perceptron structures, where the generator is responsible for generating pseudo data with the same dimensions as real data, and the discriminator is responsible for distinguishing the real data from the generated data; during the adversarial training process, the generator attempts to use generated pseudo data to fool the discriminator to make it discriminate true, and the discriminator distinguishes the generated data and the real data by improving its discriminating ability, and the two play the game, and eventually reach Nash equilibrium, that is, the sample data generated by the generator is no different from the real sample data, and the discriminator cannot distinguish the generated sample data from the real sample data;
the number of tool state samples collected by the method is 1, and dimension of the vibration signal is 6000, which is set to {v⁽ⁱ⁾}ᵢ₌₁^{l}, where v⁽ⁱ⁾∈ [symbol] ^{(m)}, m=6000, dimension of the noise data set is 1000, which is set to {n⁽ⁱ⁾}ᵢ₌₁^{l}, where n⁽ⁱ⁾∈ [symbol] ^{(k)}, k=1000, tool state data set {tool⁽ⁱ⁾}ᵢ₌₁^{l}={v⁽ⁱ⁾, n⁽ⁱ⁾}ᵢ₌₁^{l}, where tool⁽ⁱ⁾∈ [symbol] ^{(u)}, u=7000; the tool state data set of input discriminator is normalized by the maximum-minimum method, so that the input data is converted into a number between [0,1], and after the sample data is generated, inverse normalization processing is carried out, form of normalization function is shown in formula (1), and form of inverse normalization function is shown in formula (2):
$$\begin{matrix}{tool}^{( i ) ′} = \frac{{tool}^{( i )} - {tool}_{min}^{( i )}}{{tool}_{max}^{( i )} - {tool}_{min}^{( i )}} & ( 1 ) \\ {tool}^{( i )} = ( {tool}_{max}^{( i )} - {tool}_{min}^{( i )} ) * {tool}^{( i ) ′} + {tool}_{min}^{( i )} & ( 2 )\end{matrix}$$
where, tool⁽ⁱ⁾ is original data of the tool state, tool⁽ⁱ⁾′ is normalized data, toolₘᵢₙ⁽ⁱ⁾ is minimum number in the data sequence, toolₘₐₓ⁽ⁱ⁾ is maximum number in the sequence;
both the generator and the discriminator use a three-layer fully connected neural network; input data set is normalized data set; mapping formula from input layer to hidden layer and the hidden layer to output layer is shown in equation (3):
hⁱ=ƒ_{θ}(w*tool⁽ⁱ⁾′+b) (3)
where, ƒ is activation function and θ={w,b} is parameter matrix of the network, where w is connection weight between neurons in the input layer, hidden layer, and output layer, and b is threshold of neurons in the hidden layer and output layer;
the activation function of the hidden layer uses ReLU function, and the function form is as shown in formula (4):
$$ReLU ( x ) = \{ \begin{matrix}x & if x < 0 \\ 0 & if x \geq 0\end{matrix} \qquad ( 4 )$$
the activation function of the output layer uses Sigmoid function, and the function form is as shown in formula (5):
$$f ( x ) = \frac{1}{1 + {e}^{- x}} \qquad ( 5 )$$
the output of the discriminator is a binary classification, the last layer uses Sigmoid function, and the output probability value is shown in equation (6):
$$p ( y = 1 \vert x ) = \frac{1}{1 + {e}^{- {θ}^{{T}_{x}}}} \\ p ( y = 0 \vert x ) = 1 - p ( y = 1 \vert x ) = \frac{{e}^{- {θ}^{{T}_{x}}}}{1 + {e}^{- {θ}^{{T}_{x}}}} \qquad ( 6 )$$
objective function set by the method is shown in equation (7):
$${min}_{G} {max}_{D} V ( D , G ) = {E}_{x ∼ {P}_{data} ( x )} [ log D ( x ) ] + {E}_{z ∼ {P}_{z} ( z )} [ log ( 1 - D ( G ( z ) ) ) ] \qquad ( 7 )$$
the objective function and optimal solution of the discriminator are shown in equations (8) and (9):
$$\begin{matrix}{max}_{D} V ( D , G ) = {E}_{x ∼ {P}_{data} ( x )} [ log D ( x ) ] + {E}_{z ∼ {P}_{z} ( z )} [ log ( 1 - D ( G ( z ) ) ) ] & ( 8 ) \\ {D}_{G}^{*} ( x ) = \frac{{p}_{data} ( x )}{{p}_{data} ( x ) + {p}_{z} ( x )} & ( 9 )\end{matrix}$$
the objective function of the generator is shown in equation (10):
$${min}_{G} V ( D , G ) = {E}_{z ∼ {P}_{z} ( z )} [ log ( 1 - D ( G ( z ) ) ) ] \qquad ( 10 )$$
where, P_{data}(x) is data distribution of the tool state data set{tool⁽ⁱ⁾′}ᵢ₌₁^{l}, and P_{z}(z) is a prior noise distribution; D(x) represents probability that x comes from {tool⁽ⁱ⁾′}ᵢ₌₁^{l}; D(G(z)) represents probability that G(z) comes from generated data, where G(z) is sample data generated by the generator from the noise data that obey the prior distribution; E_{x˜P}_{_{data}}₍ₓ₎ represents expectation of x from the data distribution of {tool⁽ⁱ⁾′}ᵢ₌₁^{l}, E_{z˜P}_{_{z}}_{(z)} represents expectation of z from the noise distribution; the goal of the discriminator is to maximize error function to distinguish between real data and generated data, and the generator is to minimize the error function and generate data samples that are closer to the real sample data distribution;
based on the objective function, Adam optimization algorithm is used to update the parameters;
the training steps of the generative adversarial network are as follows:
(1) the generator generates p false tool state data samples {toolF⁽ⁱ⁾′}ᵢ₌₁^{p} from random noise;
(2) the generated sample data {toolF⁽ⁱ⁾′}ᵢ₌₁^{p} and original sample data {tool⁽ⁱ⁾′}ᵢ₌₁^{l} with label 1 are mixed and input into the discriminator; based on loss function, parameters of the generator are fixed, only parameters of the discriminator are updated, and the discriminator is trained to improve the discriminator's ability to distinguish true and false samples;
(3) after the discriminator is trained, the label of the generated sample {toolF⁽ⁱ⁾′}ᵢ₌₁^{p} is set to 1; based on the loss function, the error is back-propagation; in this stage, parameters of the discriminator are frozen and cannot be updated, only parameters in the generator can be updated, and the generator is trained to produce more real data samples;
(4) steps (1) to (3) are a training period; after completing a period, training process starts again from (1); after repeating multiple cycles of training the discriminator and generator, the generator's network parameters are saved;
third step, compare similarity between the generated data and the real data use the trained generator to generate sample data, compare and analyze time-frequency graph of generated tool state sample data {toolF⁽ⁱ⁾′}ᵢ₌₁^{p} and real tool state sample data {tool⁽ⁱ⁾′}ᵢ₌₁^{l}, and determine whether distribution of the generated sample data and the real sample data is the same; if they are the same, the generated sample data is denormalized, {toolF⁽ⁱ⁾′}ᵢ₌₁^{p} is generated tool state sample data after denormalization, and {toolF⁽ⁱ⁾′}ᵢ₌₁^{p} will be added to the original unbalanced data set {toolF⁽ⁱ⁾′}ᵢ₌₁^{l}; enhanced data set is {toolmix⁽ⁱ⁾}ᵢ₌₁^{l+p}={{toolF⁽ⁱ⁾}ᵢ₌₁^{p}; {tool⁽ⁱ⁾}ᵢ₌₁^{l}}; if they are not the same, return to the generative adversarial network to continue adversarial training, until the distribution of the generated sample data and the real sample data is the same;
fourth step, verify the availability of the generated sample data
the original unbalanced data set and the enhanced data set are used to train the deep learning network model to test prediction accuracy of the two and verify the availability of the generated data; training set and test set do not have any intersection, and the test set is composed of real data.
